(19) United States
(12) Patent Application Publication
(10) Pub. No.: US 2005/0121979 A1
(43) Pub. Date: Jun. 9, 2005

(54) Direct-current uninterruptible power source unit

(75) Inventors: Atsuo Matsumoto, Osaka (JP); Seiichi Okamoto, Fujisawa-shi (JP); Ryoji Shigemoto, Osaka (JP); Masanori Hatabe, Tokyo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 10/991,374

(22) Filed: Nov. 19, 2004

(30) Foreign Application Priority Data
Dec. 9, 2003 (JP) 2003-410626

(51) Int. Cl. H02J 7/00

(52) U.S. Cl. 307/66

(57) ABSTRACT

Battery packs with a plurality of rechargeable batteries connected in series so as to obtain a voltage required by a load device are detachably accommodated in a case. The battery packs are connected in parallel and each output thereof is modified to a predetermined voltage by a discharge control section. The battery packs are connected to a power source line of the load device. Each battery pack is connected through an information transmission line to a power source control section where charge and discharge thereof are controlled, as well as the lifetime is judged. Thus, only the lifetime-judged battery pack is replaced.

The present disclosure relates to subject matter contained in priority Japanese Patent Application No. 2003-410626, filed on Dec. 9, 2003, the contents of which is herein expressly incorporated by reference in its entirety.

### BACKGROUND OF THE INVENTION

1. Field of the Invention

The present invention relates to a DC uninterruptible power source unit, which supplies a backup power to a load device when a power supply trouble occurs, wherein the load device is operated by a DC power provided from an AC/DC conversion device converting an AC power supplied from an AC power source into the DC power.

2. Description of the Related Art

An uninterruptible power source unit is used to protect from a power source trouble a computer in which a crucial defect such as data destruction caused by cutting off a power supply or the like tends to occur. Known uninterruptible power source units include, for example, an on-line type power supply system, a line interactive system, and a stand-by type power supply system. These uninterruptible power source units are equipped with an inverter, and when a trouble such as power failure or the like occurs in a commercial power, the units convert a DC power into an AC power through the inverter and supply the DC power to a load device, for example, a computer.

In such uninterruptible power source unit, the rechargeable battery is controlled to be charged all the time and is ready to be able to discharge the power any time when the power source trouble occurs. However, the rechargeable battery has a usual life span of 3 to 6 years, and a deteriorating condition of the battery varies depending upon conditions used or stored. Therefore, the deteriorated rechargeable battery is designed to be replaced based upon a result of monitoring the deterioration conditions thereof.

As the conventional technique enabling replacement of the rechargeable battery in the uninterruptible power source unit there is known a power source unit, for example, disclosed in Japanese Patent Laid-Open Publication No. 11-195442. In this known power source unit, a battery box accommodating a plurality of rechargeable batteries is disposed removably in a battery receiving section of a case. In the case of replacing the rechargeable batteries, by taking out the battery box a contact pin is out of a contact socket, and the rechargeable batteries are electrically disconnected. When the battery box is inserted in the battery receiving section after replacing the old rechargeable battery in the battery box with a new rechargeable battery, the contact pin is inserted in the contact socket to electrically connect the new rechargeable batteries.

However, since, according to the replacement of the rechargeable batteries in the conventional technique, all the rechargeable batteries are taken out all together and then the deteriorated rechargeable batteries out of all are designed to be replaced. As a result in the case where the number of rechargeable batteries increases, operations to take in/out a heavy, large battery box possibly damage an advantage enabling a battery replacement without disassembling the power source unit. Also a replacement operation of the batteries is not easy since a plurality of rechargeable batteries are first disconnected, then replaced, and again the plurality of the rechargeable batteries are connected. There is no identification or display with respect to a rechargeable battery in which a trouble or a deterioration occurs and yet a battery replacement is made while cutting off the power. Accordingly, it is difficult to perform the battery replacement by a user.

### BRIEF SUMMARY OF THE INVENTION

Accordingly, the present invention has been made in view of the foregoing problems of the conventional technique and has an object of providing a DC uninterruptible power source unit, which simply replaces only a deteriorated rechargeable battery at any timing as a result of monitoring a deteriorating state of the rechargeable battery.

In order to achieve the above object, the present invention provides a DC uninterruptible power source unit, which supplies a backup power to a load device on occurrence of a power supply failure thereto, the load device being operated by a DC power supplied from an AC/DC conversion device converting an AC power supplied from an AC power source into the DC power, the DC uninterruptible power source unit comprising:
a predetermined number of battery packs each comprising: a group of batteries composed of a plurality of rechargeable batteries so as to obtain an output voltage corresponding to a power source voltage required by the load device; a pack case for receiving the group of the batteries; memory means for storing information of the group of the batteries; and detecting means for detecting an operating condition of the group of the batteries;
a case equipped with a battery pack receiving section removably accommodating the predetermined number of battery packs separately from a certain direction;
connecting means for connecting the mounted battery packs to a power line and an information transmission line;
a charge circuit for supplying a charge power to the battery packs;
a discharge circuit for adjusting a battery power outputted from the battery packs to a predetermined voltage; and
power source control means for performing a power control by controlling operations of the charge circuit, the discharge circuit, the battery packs, and entire operations of the uninterruptible power source unit, the connecting means, the charge circuit, the discharge circuit, and the power source control means being accommodated in the case.

According to this configuration, the rechargeable batteries are designed as the battery pack including means for detecting a memory of battery information and an operating condition. When the battery packs are mounted, the battery information and the operating information are read in by the power source control means connected to the information transmission line, and the read information is written and updated, to identify the trouble occurrence or the deterioration progress. When the trouble or the deterioration is detected, only the corresponding battery pack is removed from the case and as a result, connection between the power line and the information transmission line is cut by the connection means. When a new battery pack after replacement is mounted, the power line and the information transmission line are connected. Since the power source control means controls the charge circuit and the discharge circuit based upon information of each battery pack, the battery pack is fully charged and is ready to supply the backup power on occurrence of the power source trouble.

While novel features of the invention are set forth in the preceding, the invention, both as to organization and content, can be further understood and appreciated, along with other objects and features thereof, from the following detailed description and examples when taken in conjunction with the attached drawings.

### BRIEF DESCRIPTION OF THE DRAWINGS

FIG. 1 is a block diagram showing the configuration of a DC uninterruptible power source unit according to an embodiment of the invention;

FIG. 2 is a block diagram showing the configuration of a battery pack;

FIG. 3 is a perspective view showing the configuration of the battery pack;

FIG. 4 is a perspective view showing the configuration of a DC uninterruptible power source unit;

FIG. 5 is a perspective view showing the connection configuration of the battery pack; and

FIG. 6 is a block diagram showing a modified example of a DC uninterruptible power source unit.

### DESCRIPTION OF THE PREFERRED EMBODIMENTS

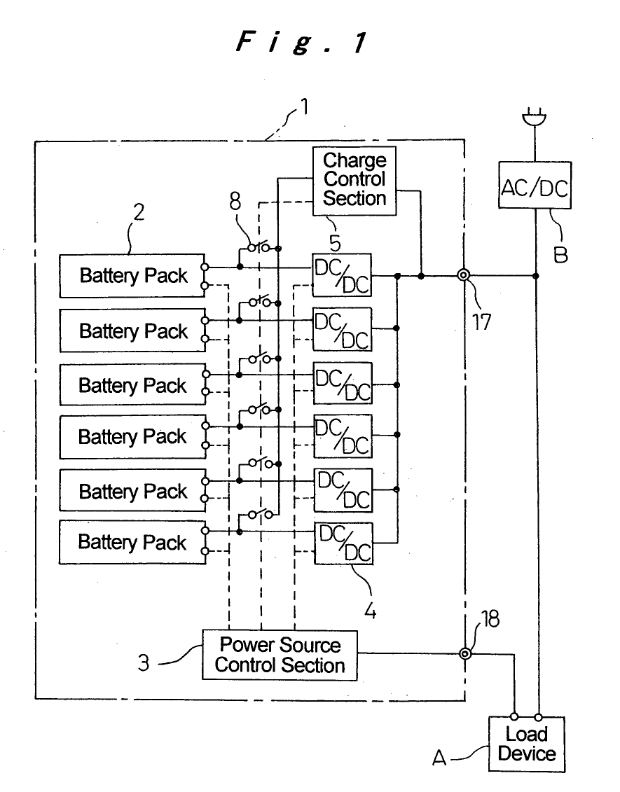

FIG. 1 shows the configuration of a DC uninterruptible power source unit 1 according to an embodiment of the invention. The DC uninterruptible power source unit 1 is constituted of a backup power source on occurrence of a power source trouble such as a power failure in a power source of a load device A such as a computer device. The load device A operates by supply of a DC power obtained by converting a commercial power into a direct current by an AC/DC conversion device B. When the power source trouble such as a power failure occurs in the commercial power as an AC power source, the DC power is supplied from the DC uninterruptible power source unit 1 to prevent occurrence of damage such as data destruction in the load device A.

A predetermined number of battery packs 2 to output the DC power having a voltage corresponding to a DC power source voltage required by the load device A are mounted in the DC uninterruptible power source unit 1. The DC uninterruptible power source unit 1 includes a charge control section 5 to output a charge power to rechargeable batteries 10 of each battery pack 2, a plurality of discharge control sections 4 to adjust an output voltage outputted from each battery pack 2 respectively to a predetermined voltage, and a power source control section 3 which controls the charge control section 5, the discharge control sections 4, and the charge/discharge powers of each battery pack 2, checks the operating conditions thereof, as well as controls an entire operation of the DC uninterruptible power source unit 1.

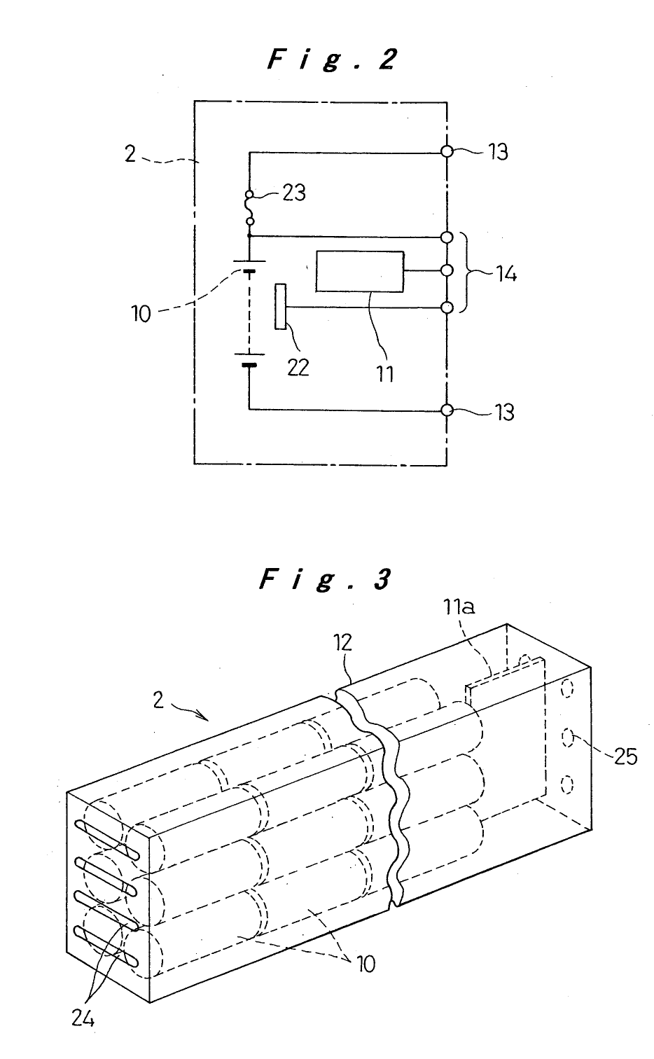

The battery pack 2, as shown in FIG. 2, is designed to obtain a desired output voltage due to a plurality of rechargeable batteries 10 connected in series. The battery pack 2 also includes a battery control circuit 11 and protection means. The battery control circuit 11 stores particular information such as a manufacturing date, a date of initial service, and an ID number of the rechargeable battery, and operating information such as the numbers of charge and discharge thereof, and inputs/outputs information from/to the power source control section 3. The protection device includes a temperature sensor 22 to detect a battery temperature, a fuse 23, and the like. A predetermined number of the battery packs, which supplies the DC power more than a maximum consumption power of the load device A, are mounted to the DC uninterruptible power source unit 1.

The battery pack 2 is constructed in such a manner that thirty cylindrical nickel metal hydride batteries as the rechargeable battery 10 are connected in series, to be arranged in a pack case 12 as shown in FIG. 3. A safety protection element such as a fuse 23 and a temperature sensor 22 to detect temperature of the rechargeable battery 10 are arranged in desired positions thereof, as well as a circuit substrate 11a having the battery control circuit 11 mounted thereon is received in the pack case 12.

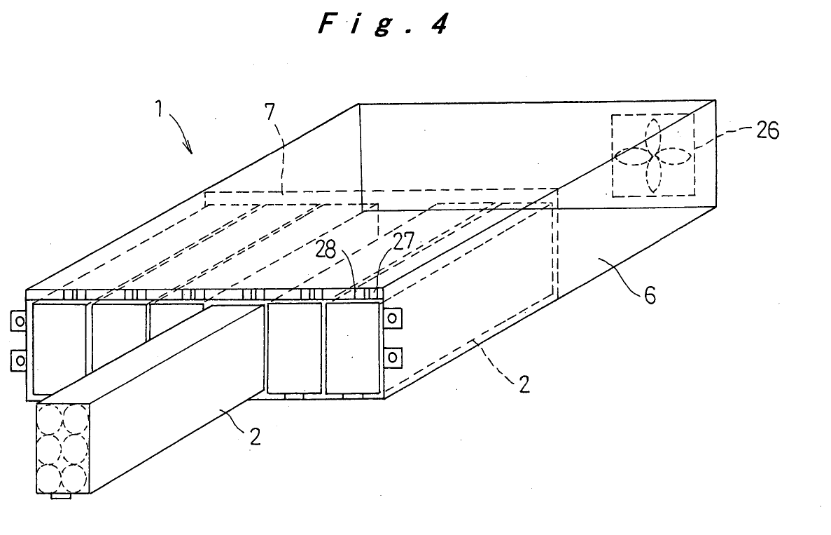

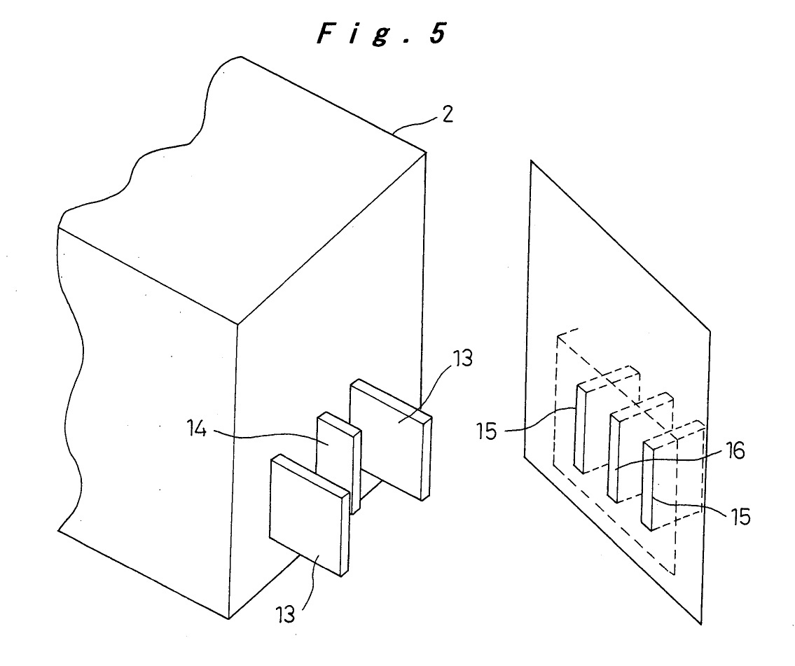

A plurality of the battery packs 2 having the above configuration, as shown in FIG. 4, are removably mounted to the DC uninterruptible power source unit 1. Herein as shown in FIG. 1, six battery packs 2 are mounted. However, in the case where the maximum consumption power of the load device A is small, the mounting number may be reduced. Each battery pack 2 is independently removable from a front face of the DC uninterruptible power source unit 1, and yet even in an energizing state of the DC uninterruptible power source unit 1. A battery pack receiving section 7 is provided in a front side of a case 6 forming a space accommodating a predetermined number of battery packs. When the battery pack 2 is inserted from a front opening face of the case 6, the battery pack 2 slides on a slide rail (not shown) and is mounted in the battery pack receiving section 7. Then as shown in FIG. 5, power connection plugs 13 and a signal connection plug 14 provided in a back face of the battery pack 2 are inserted respectively to power connection sockets 15 and a signal connection socket 16 in a bottom face of the battery pack receiving section 7 to establish a power line connection and an information transmission line connection. As shown in FIG. 5, the power connection plug 13 extends longer than the signal connection plug 14 and as a result, in mounting the battery pack 2, the information transmission line is connected after the power line is first connected. Accordingly, occurrence of defects caused by the power source being connected following the information transmission line connection is prevented. On the other hand, in removing the battery pack 2, the power line is disconnected after disconnecting the information transmission line. Accordingly, occurrence of defects caused by the power line being disconnected with the information transmission line being still connected is prevented.

When the rechargeable battery 10 is charged and discharged, heat is generated. In particular a plurality of the batteries 10 are closely arranged, heat generation thereof is affected with each other to increase temperature thereof to deteriorate battery performance. Therefore, a heat dissipation construction to promote heat dissipation of the rechargeable battery 10 is mounted. As shown in FIG. 3, a plurality of inlets 24 are formed in a front face of the pack case 12 and a plurality of outlets 25 are disposed in a back face thereof. When an exhaust fan 26 is disposed in the back face of the case 6 and turned to discharge an air in the case 6, an outside air flown through the inlets 24 flows around each rechargeable battery 10 to absorb the heat and is discharged from the outlets 25 through the case 6 to the outside. The exhaust fan 26 may be disposed in the back face of each of the battery packs 2, which more effectively performs heat dissipation. When the exhaust fan 26 is controlled based upon a battery temperature detected by the temperature sensor 22, the rechargeable batteries 10 are kept at an optimal temperature.

Since an output voltage outputted from each battery pack 2 deviates depending upon a charge condition or a deterioration condition of the rechargeable battery 10, the discharge power control sections 4 are connected to the power line of each battery pack 2 so that the output voltage of each battery pack 2 corresponds to a predetermined voltage. The output powers of respective battery packs 2 are connected in parallel through the discharge control sections 4 and are connected from a backup power output terminal 17 to a power source input of the load device A. Herein the discharge power control section 4 is constructed of a DC/DC conversion circuit and an output voltage of the discharge power control circuit 4 is controlled to be slightly lower than a DC output voltage of the AC/DC conversion circuit B. Accordingly in a condition where a power source trouble such as a power failure does not occur in the commercial power, the DC power is supplied to the load device A from the AC/DC conversion device B. On the other hand, when this power supply from the AC/DC conversion device B ceases due to the power failure or the like, the DC power is supplied from the DC uninterruptible power source unit 1 to the load device A without an instantaneous interruption of the power supply.

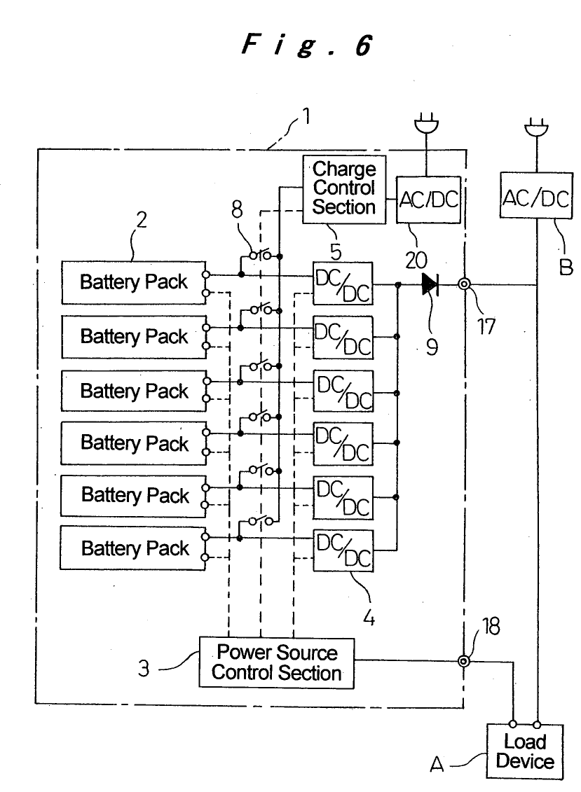

As shown in FIG. 6, the DC uninterruptible power source unit 1 may be configured such that a backflow prevention diode 9 is interposed between the discharge control section 4 and the backup power output terminal 17 to form a forward direction of power from the discharge control section 4 to the backup power output terminal 17, thereby preventing the backflow of the DC power from the AC/DC conversion device B.

When the power source control section 3 detects a condition where the backup power is supplied from the DC uninterruptible power source unit 1 to the load device A due to occurrence of the power source trouble, the information is transmitted to the load device A communicated from the information output terminal 18. When the power is not supplied from AC/DC conversion device B to the load device A even if a predetermined time elapses after the information with regard to conversion of the backup power being performed is inputted, an operation of the load device A is ended by self-completion control. A period of time during which the backup power is supplied by the DC uninterruptible power source unit 1 is limited and accordingly a software for performing a self-completion control before supply of the backup power stops is installed to the load device A. In order to prevent each battery pack 2 from being in an over-discharge state in the DC uninterruptible power source unit 1, when it is detected that the battery pack 2 is over-discharged based upon the information outputted from each battery pack 2, the power source control section 3 stops an output of the backup power from the DC uninterruptible power source unit 1.

In the case where the battery pack 2 is discharged and a charge amount thereof is reduced, or the charge amount is reduced by self-discharge or by leakage current, the charge is performed using the output power of the AC/DC conversion device B by the charge control section 5. The battery pack 2 is charged to a fully charged state at an initial charge when the DC uninterruptible power source unit 1 is installed first or after the discharge is made by the output of the backup power on occurrence of the power source trouble. When the charge amount of the battery pack 2 is reduced by about 20% from a fully charged amount due to the self-discharge or the leakage current in a stand-by state, a supplementary charge is made.

Since the charge amount of each battery pack 2 is reduced after the backup power is discharged, all the battery packs 2 are charged. The power source control section 3 and the charge control section 5 perform the charge to each battery pack 2. The power source control section 3 orderly closes charge switches 8 provided to each battery pack 2 and forms a charge circuit to each of the battery packs 2 to be charged and starts charging by the DC power supplied from the charge control section 5. The charge to each battery pack 2 is done by changing the battery pack 2 to be charged for each predetermined time, which is repeated until all the battery packs 2 are fully charged. Since the battery voltage, the battery temperature, and the charging current of each battery pack 2 in a charging condition are detected by the power source control section 3 connected through the information transmission line to each of the battery packs 2, the power source control section 3 controls the charging to each battery pack 2 to continue the charging operation till each battery pack 2 becomes in a fully charged condition.

The information transmission line communicating information between each battery pack 2 and the power source control section 3, as shown in FIG. 2, is configured by providing a transmission line of detected data of the battery voltage and the battery temperature, and input/output lines of information to the battery control circuit 11. Accordingly, the power source control section 3 detects the state of the reduced charge amount for each battery pack 2. When it is detected that the charge amount is reduced by 20% from a fully charged state, the power source control section 3 closes the charge switch 8 corresponding to the battery pack 2 to be charged and starts charging by supplying a charge power from the charge control section 5.

In the above configuration, the DC power source for charging the battery pack 2 is the AC/DC conversion device B, but as shown in FIG. 6, the charge power is supplied to the charge control section 5 from a charge-power power source 20 connected to the commercial power. In the case of implementing this configuration, it is preferable that an operating power of the DC uninterruptible power source unit 1 is provided from the charge-power power source 20. According to this configuration, supply of the charging power is not required to rely on the AC/DC conversion device B, and voltage fluctuations due to occurrence of the charging power will not affect the power supply to the load device A.

The DC uninterruptible power source unit 1 according to the above configuration may be mounted to a rack in accordance with the EIA standard, and is suitable for use as a backup power source of a server computer of a computer network mounted together with the AC/DC conversion device B on the rack. When a failure of the AC/DC conversion device B occurs or a trouble such as a power failure occurs in the commercial power as the AC power source, it is required to maintain a condition where a DC power is supplied from the DC uninterruptible power source unit 1 to the load device A without an instantaneous interruption of power. Accordingly, the battery pack 2 for generating a DC power is needed to maintain a state where the performance is not deteriorated.

The rechargeable battery 10 differs in deterioration progress depending upon the service condition or the stored condition and has a service life span of 3 to 6 years. Therefore, by monitoring a failure or a deteriorating condition thereof, the defective or deteriorated battery pack 2 is required to be replaced by judging that it has come to lifetime. Lifetime of the rechargeable battery is judged based upon the manufacturing date or the number of the charge/discharge of the rechargeable battery 10 which the battery control circuit 11 of each battery pack 2 is storing, but it is preferable that lifetime is judged by a method measuring an impedance of the rechargeable battery 2 in the case of a device like an uninterruptible power source unit where the charge/discharge are not so often performed.

A lifetime judgment based upon the impedance measurement is made such that the power source control section 3 supplies pulse discharge for connecting dummy loads having two different resistances to the power line of the battery pack 2 for a short time, and the impedance is obtained by dividing the difference between the battery voltages outputted from the battery control circuit 11 of each battery pack 2 for each discharge current amount over the difference between the discharge current amounts. When the measured impedance becomes more than twice the initial value, it is judged that the rechargeable battery 10 has come to the lifetime.

In the case where the rechargeable battery 10 is judged in a comprehensive manner to have come to the lifetime based upon the information of the lifetime judgment by the impedance measurement or the information of the charge/discharge times recorded for each battery pack 2, a user is prompted to replace the battery pack 2 by lighting a display lamp 28 of the corresponding battery pack 2. Further, it is also preferable to indicate a display on a display device of the load device A to prompt replacement of the battery pack 2.

When the battery pack 2 is replaced, a replacement switch 27 disposed in the front face of the case 6 is pushed down, and the replacement information is transmitted to the power source control section 3. Accordingly, in the case where the power source control section 3 is performing the information transmission or the like to the battery control circuit 11, the power source control section 3 performs a control to stop it, and therefore, the battery pack 2 is removed from the case 6. The replacement of the battery pack 2 is done by drawing it even in an energizing state. When a new battery pack 2 for replacement is inserted, the power line and the information transmission line are connected. The power source control section 3 reads out the battery information from the battery control circuit 11 of the battery pack 2 newly mounted, to start charging to the rechargeable battery 10 by the charge control section 5.

In a memory of the battery control circuit 11 of the battery pack 2, the particular information such as the manufacturing date or the ID number is written in advance. When the battery pack 2 is installed to the DC uninterruptible power source unit 1, the information such as the initial date of service, the numbers of the charge times and the discharge times is written in the memory from power source control section 3. With regard to writing the information in the memory, two memories are disposed and the information is written in one of the memories once and after the transmission of the information to be written in is finished, the information written in the other memory is updated. Therefore, even in the case where the battery pack 2 is removed in the middle of the information transmission, the previous information is preserved.

As explained above, since the DC uninterruptible power source unit according to the present invention is configured in such a manner that a plurality of battery packs are connected in parallel, and each battery pack includes a plurality of rechargeable batteries outputting a DC power of a voltage required by a load device, and means for storing information and detecting the operating condition integrated with the rechargeable battery. Therefore, the battery pack to be replaced is extracted by detecting the failure or deterioration condition for each battery pack. Namely, only the battery pack to be replaced is removed, and then a new battery pack 2 is simply installed. Accordingly, replacement operations for battery pack 2 are easily performed by a user. Since the DC uninterruptible power source unit outputs the DC power required by the load device, an AC/DC conversion device such as an inverter is not necessary. Since an output power is easily adjusted corresponding to consumption power of the load device, an uninterruptible power source unit is constituted at a lower cost.

Although the present invention has been fully described in connection with the preferred embodiments thereof, it is to be noted that various changes and modifications apparent to those skilled in the art are to be understood as included within the scope of the present invention as defined by the appended claims unless they depart therefrom.

1. A DC uninterruptible power source unit, which supplies a backup power to a load device on occurrence of a power supply failure, the load device being operated by a DC power supplied from an AC/DC conversion device converting an AC power supplied from an AC power source into the DC power, the DC uninterruptible power source unit comprising:
a predetermined number of battery packs each comprising: a group of batteries composed of a plurality of rechargeable batteries so as to obtain an output voltage corresponding to a power source voltage required by the load device; a pack case for receiving the group of the batteries; a memory unit for storing information of the group of the batteries; and a detector for detecting an operating condition of the group of the batteries;
a case equipped with a battery pack receiving section removably accommodating the predetermined number of battery packs separately from a certain direction;
a connector for connecting a power line and an information transmission line to the mounted battery packs;
a charge circuit for supplying a charge power to the battery packs;
a discharge circuit for adjusting a battery power outputted from the battery packs to a predetermined voltage; and
a power source controller for performing a power control by controlling operations of the charge circuit, the discharge circuit, the battery packs, and entire operations of the uninterruptible power source unit, the connector, the charge circuit, the discharge circuit, and the power source controller being accommodated in the case.

2. The DC uninterruptible power source unit according to claim 1, wherein
the plurality of battery packs mounted in the battery pack receiving section are connected in parallel through the discharge circuit to be removable in an energizing state.

3. The DC uninterruptible power source unit according to claim 1, wherein
the discharge circuit is controlled so that a discharge current from the battery pack is equalized.

4. The DC uninterruptible power source unit according to claim 1, wherein
when removing the battery pack, the connector disconnects the information transmission line first and thereafter, disconnects the power line, and when mounting the battery pack, the connector connects the power line first and thereafter, connects the information transmission line.

5. The DC uninterruptible power source unit according to claim 1, wherein
the battery pack includes two or more memory units, and
after writing information in one of the memory units is finished, memory information of the other memory unit is updated based upon the written information.

6. The DC uninterruptible power source unit according to claim 1, wherein
the number of the battery packs to be mounted increases or decreases depending on a maximum consumption power of the load device.

7. The DC uninterruptible power source unit according to claim 1, wherein
a voltage of the backup power is set lower than a voltage of the DC power supplied from the AC/DC conversion device to the load device.

8. The DC uninterruptible power source unit according to claim 7, wherein
a backflow prevention diode is connected to form a forward direction of power toward a power line of the DC power supplied from an output terminal of the backup power to the load device.

9. The DC uninterruptible power source unit according to claim 1, wherein
a charge power to the battery pack is obtained from the AC/DC conversion device.

10. The DC uninterruptible power source unit according to claim 1, wherein
a charge power to the battery pack is obtained from an AC power source.

11. The DC uninterruptible power source unit according to claim 1, wherein
the plurality of battery packs are charged by sequentially switching them.

12. The DC uninterruptible power source unit according to claim 1, wherein
an air blowing construction where an air passes from an inlet through each of the rechargeable batteries to an outlet is formed in at least one of the battery pack and the case.

13. The DC uninterruptible power source unit according to claim 1, wherein
the power source controller performs a lifetime judgment of each battery pack based upon at least one of information obtained from each battery pack and an impedance measurement of the rechargeable battery, and indicates a replacement display of the lifetime-judged battery pack.

14. The DC uninterruptible power source unit according to claim 13, wherein
the power source controller obtains an impedance from a difference in voltage decrease generated when pulse discharges having a different current value are supplied from the battery pack, and judges the lifetime based upon comparing the obtained impedance with a predetermined value.

15. The DC uninterruptible power source unit according to claim 2, wherein
the discharge circuit is controlled so that a discharge current from the battery pack is equalized.

16. The DC uninterruptible power source unit according to claim 2, wherein
when removing the battery pack, the connector disconnects the information transmission line first and thereafter, disconnects the power line,
and when mounting the battery pack, the connector connects the power line first and thereafter, connects the information transmission line.
